(19) United States
(12) Patent Application Publication
(10) Pub. No.: US 2005/0170232 A1
(43) Pub. Date: Aug. 4, 2005

(54) Durable, low transient resistence between bipolar plate and diffusion media

(76) Inventor: Harald Schlag, Russelsheim (DE)

Correspondence Address: HARNESS, DICKEY & PIERCE, P.L.C., P.O. BOX 828, BLOOMFIELD HILLS, MI, 48303, US

(21) Appl. No.: 10/771,917

(22) Filed: Feb. 4, 2004

(51) Int. Cl. H01M 2/08; H01M 8/10; H01M 4/94

(52) U.S. Cl. 429/35; 429/30; 429/44; 429/36

(57) ABSTRACT

A fuel cell includes a first polymer electrolyte membrane (PEM) and a plate having a series of flow channels formed in a first surface. A first diffusion medium is disposed between the first PEM and the plate and is in direct contact with the first surface. A first sealing layer secures the direct contact between the first diffusion media and the plate and seals the first surface.

### FIELD OF THE INVENTION

The present invention relates to fuel cells, and more particularly to enhancing electrical communication between diffusion media and a conductive plate of a fuel cell.

### BACKGROUND OF THE INVENTION

Fuel cell systems include a fuel cell stack that produces electrical energy based on a reaction between a hydrogen-based feed gas (e.g., pure hydrogen or a hydrogen reformate) and an oxidant feed gas (e.g., pure oxygen or oxygen-containing air). The hydrogen-based feed gas and oxidant feed gas are supplied to the fuel cell stack at appropriate operating conditions (i.e., temperature and pressure) for reacting therein. The proper conditioning of the feed gases is achieved by other components of the fuel cell stack to provide the proper operating conditions.

The fuel cell stack includes multiple fuel cells electrically connected in series. Each fuel cell includes a polymer electrolyte membrane (PEM) sandwiched between a cathode plate and an anode plate. Electrically conductive diffusion media are disposed between the PEM and both the cathode and anode plates. The cathode plate includes cathode flow channels, through which the oxidant feed gas flows. Similarly, the anode plate includes anode flow channels, though which the hydrogen feed gas flows. The cathode and anode flow channels are open to the diffusion media to enable diffusion of the oxidant and hydrogen feed gases to the PEM. In some instances, a bipolar plate is implemented between fuel cells and includes cathode flow channels formed on one side for supplying the oxidant feed gas to one PEM. Anode flow channels are formed on a second side for supplying the hydrogen feed gas to an adjacent PEM.

The fuel cell system generates electrical current that is conducted through the various layers of the fuel cell stack, including the diffusion media, cathode plates and anode plates. In the case of implementing bipolar plates, the current is conducted through the bipolar plate. Therefore, good electrical contact must be ensured between the adjacent layers of the fuel cell stack. In some instances an oxide layer can form on conductive surfaces of the individual layers. The oxide layer inhibits electrical conductivity through the fuel cell stack. As more oxide layers form within the stack, stack efficiency and thus, power output decrease.

### SUMMARY OF THE INVENTION

Accordingly, the present invention provides a fuel cell having a first polymer electrolyte membrane (PEM) and a plate having a series of flow channels formed in a first surface. A first diffusion medium is disposed between the first PEM and the plate and is in direct contact with the first surface. A first sealing layer secures the direct contact between the first diffusion media and the plate and seals the first surface. To ensure good electrical contact between the first diffusion medium and the plate, any insulating layers such as, but not limited to, oxide layers are removed from the plate.

In one feature, the first sealing layer is an epoxy resin.

In another feature, the first sealing layer is electrically conductive.

In another feature, the first sealing layer is electrically non-conductive.

In another feature, a first series of lands are formed in the plate, and the first diffusion media is in direct contact with the first series of lands.

In another feature, the first sealing layer is initially applied to the first surface in a non-cured state and a portion of the first diffusion media is immersed through the first sealing layer to contact the first surface. The first sealing layer achieves a cured state to secure the first diffusion media to the first surface.

In still another feature, the fuel cell further includes a second series of flow channels formed in a second surface of the plate and a second diffusion medium that is disposed between a second PEM and the plate and that is in direct contact with the second surface. A second sealing layer secures the direct contact between the second diffusion media and the plate and seals the second surface. To ensure good electrical contact between the second diffusion medium and the plate, any insulating layers are removed from the plate.

A second series of lands are formed in the plate, and the second diffusion media is in direct contact with the second series of lands. The second sealing layer is initially applied to the second surface in a non-cured state and a portion of the second diffusion media is immersed into the second sealing layer to contact the second surface. The second sealing layer achieves a cured state to secure the second diffusion media to the second surface.

In yet another feature, the plate constitutes a bipolar plate, wherein the first series of flow channels facilitate a cathode feed gas flow and the second series of flow channels facilitate an anode feed gas flow. The plate may include cooling channels formed therethrough.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration of a fuel cell system including a fuel cell stack according to the present invention;

FIG. 2 is a schematic cross-sectional view of the fuel cell stack;

FIG. 3 is an exploded schematic cross-sectional view of the fuel cell stack; and

FIG. 4 is a more detailed cross sectional view of the fuel cell stack illustrating a sealing layer according to the present invention.

### DETAILED DESCRIPTION OF THE PREFERRED EMBODIMENTS

The following description of the preferred embodiments is merely exemplary in nature and is in no way intended to limit the invention, its application, or uses.

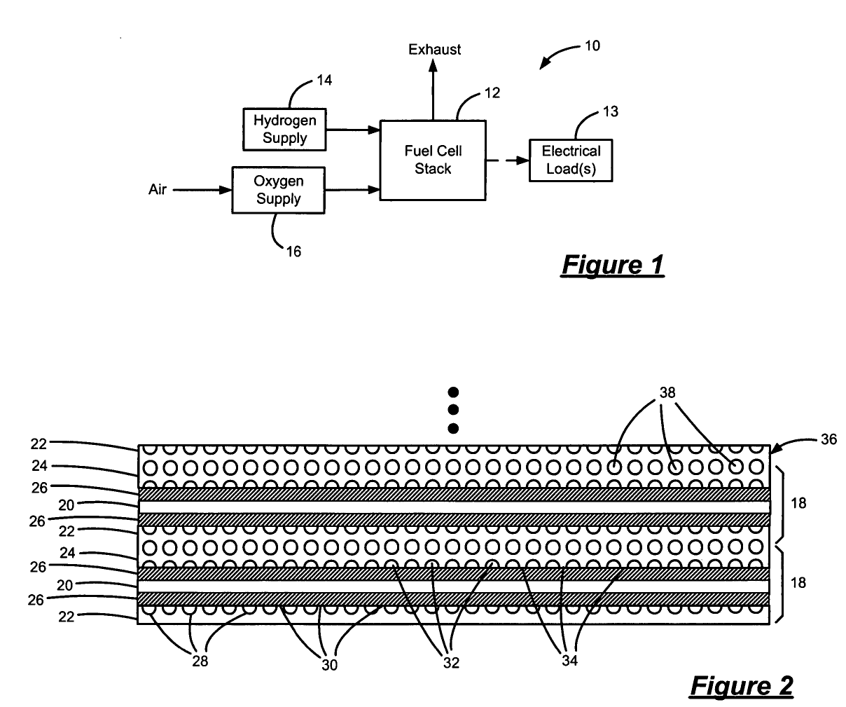

Referring now to FIG. 1, a fuel cell system 10 is shown. The fuel cell system 10 includes a fuel cell stack 12, a hydrogen supply unit 14 and an oxygen supply unit 16. The fuel cell stack 12 produces electrical power to power an electrical load or loads 13. The electrical load(s) 13 can include an electric motor, lights, heaters or any other type of electrically powered components.

The hydrogen supply unit 14 supplies a hydrogen feed gas to the fuel cell stack 12. In the case of the hydrogen feed gas being pure hydrogen, the hydrogen supply unit 14 includes a storage vessel and the associated plumbing and controls (not shown) to supply the hydrogen to the fuel cell stack 12. In the case of the hydrogen feed gas being a hydrogen reformate, the hydrogen supply unit 14 includes a storage vessel for storing a base fuel and the components, plumbing and controls (not shown) required to dissociate the base fuel into the hydrogen containing feed gas and to supply the hydrogen feed gas to the fuel cell stack 12. The oxidant feed gas is generally provided as oxygen-rich air. Thus, the oxygen supply unit 16 generally includes a compressor, plumbing and controls (not shown) required to supply the oxidant feed gas to the fuel cell stack 12.

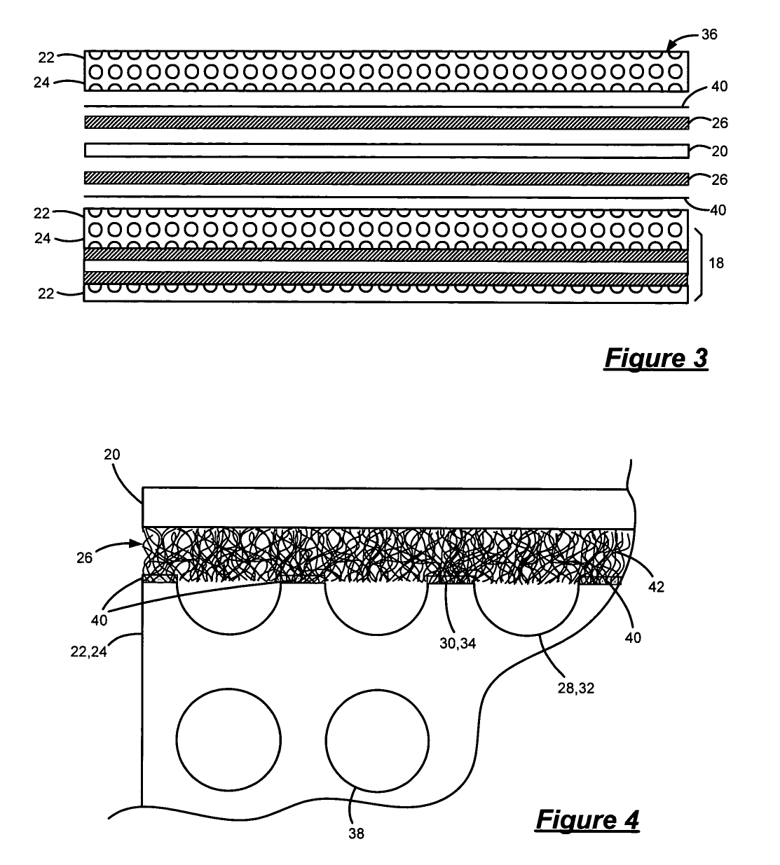

Referring now to FIGS. 2 and 3, the fuel cell stack 12 includes multiple fuel cells 18 electrically connected in series. Each fuel cell 18 includes a polymer electrolyte membrane (PEM) 20 sandwiched between a cathode plate 22 and an anode plate 24. Electrically conductive diffusion media 26 are disposed between the PEM 20 and both the cathode and anode plates 22,24. The cathode plate 22 includes cathode flow channels 28, through which the oxidant feed gas flows. The cathode flow channels 28 define raised portions or lands 30 that divide the cathode flow channels 28. Similarly, the anode plate 24 includes anode flow channels 32, through which the hydrogen feed gas flows. The anode flow channels 32 define raised portions or lands 34 that divide the anode flow channels 32.

The diffusion media 26 rest on and are in electrical communication with the lands 30,34 disposed between the cathode and anode flow channels 28,32, respectively. The cathode and anode flow channels 28,32 are open to the diffusion media 26 to enable diffusion of the oxidant and hydrogen feed gases to the PEM 20. In some instances, a bipolar plate 36 is implemented within the fuel cells 18 and includes the cathode flow channels 28 formed on one side for supplying the oxidant feed gas to one PEM 20. The anode flow channels 32 are formed on a second side for supplying the hydrogen feed gas to an adjacent PEM 20. Coolant flow channels 38 are formed through the bipolar plate 36 and facilitate coolant flow through the fuel cell 18.

Referring now to FIG. 4, assembly of the fuel cells 18 according to the present invention will be described in detail. The lands 30,34 (i.e., contact surface for diffusion media 26) of the cathode and anode plates 22,24 are cleaned to remove any oxide, insulating or otherwise poor conductive layers. Poor conductive layers are layers that inhibit or prohibit electrical conductivity between the plates 22,24 and the diffusion media 26. Removal of the poor conductive layers can be achieved electrochemically or using other processes. Any cleaning solution that removes the poor conductive layers can be implemented including, but not limited to, HF, H₂SO₄ and mixtures thereof. An adhesive layer 40 is applied to the surface of the lands 30,34. More particularly, the adhesive layer 40 covers the lands 30,34 disposed between the cathode and anode flow channels 28,32.

The adhesive layer 40 can include any material that is initially soft and that hardens including, but not limited to an epoxy resin. The diffusion media 26 is pressed into the adhesive layer 40 such that the diffusion media fibers 42 come into direct contact with the lands 30,34. In this manner, the diffusion media 26 is in direct electrical contact with the cathode and anode plates 22,24. Because the diffusion media 26 and the cathode and anode plates 22,24 are in direct electrical contact, the adhesive layer 40 need not be electrically conductive. It is anticipated, however, that the adhesive layer 40 can be electrically conductive.

The adhesive layer 40 cures or hardens to secure the diffusion media 26 to the cathode and anode plates 22,24. The hardened adhesive layer 40 seals the surface of the lands 30,34 to prevent oxide layers from forming. More particularly, the adhesive layer 40 is gas tight, preventing oxygen-containing gases from oxidizing the surface of the lands 30,34. Further, the adhesive layer 40 seals the contact between the diffusion media 26 and the lands 30,34. In this manner, a durable, low resistance electrical connection is provided between the diffusion media 26 and the cathode and anode plates 22,24.

The description of the invention is merely exemplary in nature and thus, variations that do not depart from the gist of the invention are intended to be within the scope of the invention. Such variations are not to be regarded as a departure from the spirit and scope of the invention.

1. A fuel cell, comprising:
a first polymer electrolyte membrane (PEM);
a plate having a first series of flow channels formed in a first surface;
a first diffusion medium that is disposed between said first PEM and said plate and that is in direct contact with said first surface; and
a first sealing layer that secures said direct contact between said first diffusion media and said plate and that seals said first surface.

2. The fuel cell of claim 1 wherein said first sealing layer is an epoxy resin.

3. The fuel cell of claim 1 wherein said first sealing layer is electrically conductive.

4. The fuel cell of claim 1 wherein said first sealing layer is electrically non-conductive.

5. The fuel cell of claim 1 further comprising a first series of lands formed in said plate, wherein said first diffusion media is in direct contact with said first series of lands.

6. The fuel cell of claim 1 wherein said first sealing layer is initially applied to said first surface in a non-cured state and a portion of said first diffusion media is immersed through said first sealing layer to contact said first surface, said first sealing layer achieving a cured state to secure said first diffusion media to said first surface.

7. The fuel cell of claim 1 further comprising:
a second series of flow channels formed in a second surface of said plate;
a second diffusion medium that is disposed between a second PEM and said plate and that is in direct contact with said second surface; and
a second sealing layer that secures said direct contact between said first diffusion media and said plate and that seals said second surface.

8. The fuel cell of claim 7 wherein said second sealing layer is an epoxy resin.

9. The fuel cell of claim 7 wherein said second sealing layer is electrically conductive.

10. The fuel cell of claim 7 wherein said second sealing layer is electrically non-conductive.

11. The fuel cell of claim 7 further comprising a second series of lands formed in said plate, wherein said second diffusion media is in direct contact with said second series of lands.

12. The fuel cell of claim 7 wherein said second sealing layer is initially applied to said second surface in a non-cured state and a portion of said second diffusion media is immersed into said second sealing layer to contact said second surface, said second sealing layer achieving a cured state to secure said second diffusion media to said second surface.

13. The fuel cell of claim 7 wherein said plate is a bipolar plate, wherein said first series of flow channels facilitate a cathode feed gas flow and said second series of flow channels facilitate an anode feed gas flow.

14. The fuel cell of claim 13 wherein said plate includes cooling channels formed therethrough.

15. A method of assembling a fuel cell, comprising:
applying a first adhesive layer to a cathode surface of a cathode plate in a non-cured state;
pressing a first diffusion media into contact with said cathode surface while said first adhesive layer is in said non-cured state; and
curing said first adhesive layer into a cured state to secure contact between said first diffusion media and said cathode surface and to seal said cathode surface from contact with an cathode feed gas.

16. The method of claim 15 wherein said first adhesive layer is an epoxy resin.

17. The method of claim 15 wherein said first adhesive layer is electrically conductive.

18. The method of claim 15 wherein said first adhesive layer is electrically non-conductive.

19. The method of claim 15 further comprising removing a poor conducting layer from said cathode surface prior to said step of applying said first adhesive layer.

20. The method of claim 15 further comprising:
applying a second adhesive layer to an anode surface of an anode plate in a non-cured state;
pressing a second diffusion media into contact with said anode surface while said second adhesive layer is in said non-cured state; and
curing said second adhesive layer into a cured state to secure contact between said second diffusion media and said anode surface and to seal said anode surface from contact with an anode feed gas.

21. The method of claim 20 wherein said second adhesive layer is an epoxy resin.

22. The method of claim 20 wherein said second adhesive layer is electrically conductive.

23. The method of claim 20 wherein said second adhesive layer is electrically non-conductive.

24. The method of claim 20 further comprising removing a poor conducting layer from said anode surface prior to said step of applying said second adhesive layer.

25. A fuel cell system, comprising:
a fuel cell stack including a plurality of fuel cells in electrical series connection, each of said plurality of fuel cells comprising:
a polymer electrolyte membrane (PEM);
a cathode plate having a series of cathode flow channels formed in a cathode surface thereof;
a first diffusion medium that is disposed between said first PEM and said plate and that is in direct contact with said cathode surface; and
a first sealing layer that secures said direct contact between said first diffusion media and said plate and that seals said cathode surface; and

26. The fuel cell system of claim 25 wherein said first sealing layer is an epoxy resin.

27. The fuel cell system of claim 25 wherein said first sealing layer is electrically conductive.

28. The fuel cell system of claim 25 wherein said first sealing layer is electrically non-conductive.

29. The fuel cell system of claim 25 further comprising a first series of lands formed in said plate, wherein said first diffusion media is in direct contact with said first series of lands.

30. The fuel cell system of claim 25 wherein said first sealing layer is initially applied to said cathode surface in a non-cured state and a portion of said first diffusion media is immersed through said first sealing layer to contact said cathode surface, said first sealing layer achieving a cured state to secure said first diffusion media to said cathode surface.

31. The fuel cell system of claim 25 further comprising:
an anode plate having a series of anode flow channels formed in an anode surface thereof;
a second diffusion medium that is disposed between a second PEM and said anode plate and that is in direct contact with said anode surface; and
a second sealing layer that secures said direct contact between said second diffusion media and said anode plate and that seals said anode surface.

32. The fuel cell system of claim 31 wherein said second sealing layer is an epoxy resin.

33. The fuel cell system of claim 31 wherein said second sealing layer is electrically conductive.

34. The fuel cell system of claim 31 wherein said second sealing layer is electrically non-conductive.

35. The fuel cell system of claim 31 further comprising a second series of lands formed in said anode plate, wherein said second diffusion media is in direct contact with said second series of lands.

36. The fuel cell system of claim 31 wherein said second sealing layer is initially applied to said anode surface in a non-cured state and a portion of said second diffusion media is immersed into said second sealing layer to contact said anode surface, said second sealing layer achieving a cured state to secure said second diffusion media to said anode surface.

37. The fuel cell of claim 31 wherein said cathode and anode plates constitute a bipolar plate, wherein said cathode flow channels facilitate a cathode feed gas flow and said anode flow channels facilitate an anode feed gas flow.

38. The fuel cell system of claim 37 wherein said bipolar plate includes cooling channels formed therethrough.
